(19) United States
(12) Patent Application Publication
(10) Pub. No.: US 2021/0230366 A1
(43) Pub. Date: Jul. 29, 2021

(54) MULTIFUNCTIONAL POLY METHYLAMINE SURFACTANT AND ITS METHOD OF PREPARATION

(71) Applicant: Igor STATNÎI, Bucuresti (RO)

(72) Inventor: Igor STATNÎI, Bucuresti (RO)

(21) Appl. No.: 15/734,829

(22) PCT Filed: Jul. 17, 2018
(86) PCT No.: PCT/RO2018/000014

§ 371 Date: Dec. 3, 2020

(30) Foreign Application Priority Data
Jun. 12, 2018 (RO) A 2018 00412

(51) Int. Cl. C08G 73/02; C10L 10/02; C10L 10/10; C10L 10/14; C10L 10/04; C10L 1/2383; B01F 17/00

(52) U.S. Cl. CPC C08G 73/0213; C10L 10/02; C10L 10/10; C10L 2250/04; C10L 10/04; C10L 1/2383; B01F 17/005; C10L 10/14

(57) ABSTRACT

The invention relates to the preparation and development of a method for a process for preparing a Poly Methylamine surfactant. The process consists of a mixture of methanol and ethanolamine in a molar ratio ranging from 1.0-0.6 to 3.0-0.4 at a temperature of 45-50° C., resulting in a non-hazardous substance, without toxic effects for human health, at the same time having high-quality cleaning, high- and very low temperature resistance, with surface active agent (surfactant) properties. Used as a fuel additive, reduces harmful exhaust gas emissions to the atmosphere, raises the octane number in gasoline, prevents the formation of ice crystals in diesel fuel.

The invention relates to an ecologically biodegradable product and the process for the preparation of this Poly Methylamine surfactant. It can be used in the chemical industry as a surfactant for the production of chemical detergents (for the maintenance of surfaces of glass and car mirrors, plastics, leather and textiles), surfactants, wetting agents, emulsifiers, foaming agents, dispersers in the composition of technical liquids for special use and accessories for cars (bodies, motors, wheels and wheel covers) as well as for the production of paints and varnishes, or in the automotive industry as a fuel additive. The analysis of the literature data shows that as gasoline-alcohol mixtures stabilizers are proposed to be used: normal and branched aliphatic structure C3-C12 alcohols, Alkyl Acetates, simple ethers and compounds and metal-organic derivatives thereof, Ketones, Amines, Amino Acid Surfactants (AAS) as well as glycols and ethers thereof, Aldehydes, Ketals, Acetals, Alkyl Carbonates, carbonic acids and mixtures of these compounds. The addition of the listed compounds prevents stratification of gasoline containing alcohol in the temperature range from minus 40 to plus 40° C., increases the anti-knock properties(octane number), as well as the reduction of the harmful components in the exhaust gases, the deposition of the resins in engine power system, extended service life of exhaust gas cleaning catalysts.

It is known that the improvement of environmental indicators is largely related to the transition to the use of fuels with improved ecological properties, in particular alcohol-containing fuels. The positive properties of alcohol containing fuels are obvious when used in pure state. Due to the high compression and low-blend operation, a high efficiency of engine operation and a low CO₂ content in the gases produced by the operation of internal combustion engines are achieved. For this, however, a new engine is to be developed that works only based on alcohol. If more than 10% of alcohol is introduced into gasoline, their disadvantages become non-essential. It is known that when the content of small molecule alcohols (methanol and ethanol) in the fuel mix is less than 10%, it is not necessary to modernize the engines and at the same time there are no difficulties in operating the cars. In this context, lately, the maximum attention is paid to the development of additives based on such alcohols. However, the experience of using small molecule alcohols in gasoline has highlighted a number of issues. These include: Phase instability of gasoline-alcohol fuels (it is known that C1-C3 alcohols are mixed with water in any proportions and presence of water in alcohol-containing gasoline is the cause of phase separation), corrosive activity with relation to metal materials of the engine etc.

Thus, the introduction of methanol or ethanol in gasoline requires the mandatory inclusion of stabilizing additives in its composition, which make possible to homogenize the gasoline-water-alcohol system and of anticorrosive additives according to EN 228-2000. The UA 73613 U Patent makes known. Ethanolamine Poly Methylate of the formula {[NRR₁—(CH₂—CH₂—OH₂)ₖ]⁺(CH₃O)ₖ⁻}ₙ, where R═R₁═H, k=l or R═H, R₁═CH₂—CH₂—OH₂, k=2 or R═R₁═CH₂—CH₂—OH₂, k=3 n=200-2000, in the form of aqueous solutions useful as non-ionic detergents (PME dispersing agent).

The disadvantages of the prior explained process are that methanol is a toxic solvent and that the methanol is persistent in the product, having toxic effects on the human body and posing a major risk to human health. Methanol having 3 degree of toxicity, being Acutely Toxic, 3 H301 Toxic if swallowed, Acutely Toxic 3 1-H311 Toxic in contact with skin, Acutely Toxic 3 H331 Toxic if inhaled.

The process involves, also, the use, as catalysts, of chemical substances, such as: Ethoxylated Nonylphenol - chemical name and the trade name of NEONOL, and the primary synthetic oxyethylate alcohol with the trade name SINTANOL, which are interdisciplinary substances in Europe.

Out of EP0592947 patent application a detergent containing as a surfactant a mono, di or tri ethylamine derivative, as well as an Ethoxylated Non-ionic surfactant is known. According to the invention, the product contains anionic sulphuric surfactants. They have an impact on the respiratory tract, as during the manufacturing process, toxins are released into the environment, such as benzene, which is part of the carcinogenic substances and of the dangerous substances for the reproductive system.

Phosphates—are designed to increase the efficiency of detergents by attenuating water hardness and fighting dirt on laundry during washing. Their negative side is that they come in the aquatic environment and stimulate the growth of algae, which leads to the decrease of the oxygen content in the water, making the life of the aquatic fauna impossible.

Phenols—extremely dangerous substances for people who have allergies and can even cause them death. It is easily absorbed by the body, with negative effects on the central nervous system, heart, blood vessels, liver and kidney.

The optical brighteners—these substances create the illusion of white, actually increasing the shine of the clothes, by converting the rays of the UV (ultraviolet) spectrum to light (without any effect on the degree of cleanliness of the laundry). In humans, causes skin irritation in case of prolonged exposure to sun. Studies show that they are very toxic to fish and cause bacterial mutations.

Artificial perfumes—of petrochemical origin, are not biodegradable. Studies have shown negative effects on fish and mammals. It often causes allergies, irritations to the skin and eyes.

The technical problem that the present invention seeks to solve is to develop a process for the preparation of a Poly Methylamine surfactant, to produce a methanol-free product and as a consequence of low volatility, not to harm the environment and human health, fact which makes their widespread use in so-called “green chemistry”. The main conditions of “green chemistry” are:
Making the most of the initial materials in the synthesis process;
Minimal use of auxiliary substances (solvents, extraction agents, etc.);
The use of renewable raw materials;
Applying methods with less toxic substances;
Exclusion of auxiliary stages (protection of functional groups, introduction of substitutes, etc.);
Application of catalytic systems;
Real-time analytical control methods to prevent the formation of harmful substances;
Minimizing energy consumption;
Correct choice of substance aggregation status to prevent leakage, explosions, fire;
Effective replacement of use, purification by preventing releases and by-products.

This multifunctional additive with Poly Methylamine content (PMTA) possesses surfactant properties that reduce surface tension of liquids, favouring the dispersion of other substances that do not normally dissolve in the liquid and do not form stable foam.

It possesses properties of an anionic surfactant which allows homogeneity of the gasoline-water-alcohol system. In addition to increasing the detonation resistance of automotive gasoline and the phasic stability of gasoline-alcohol fuels, the product has anticorrosive additive properties.

The process, according to the invention, has the advantage that methanol is consumed totally and is no longer present in the product obtained. As a result, the Poly Methylamine active agent obtained by this method is a non-toxic product, devoid of toxic effects for the human body. In addition, as a surfactant, it does not form ice crystals and does not freeze at very low temperatures; it is part of surface active agents (surfactants) that combine resistance to thermal action with high surface active properties; as an additive in fuels, reduces harmful exhaust (toxic emissions) of exhaust gases into the atmosphere. Also, as a gasoline additive, it raises its octane number and, as an additive in diesel fuel, prevents the formation of ice particles, and is also an anti-corrosive product.

The proposed solution consists in a process for the preparation of a Poly Methylamine surfactant where in the first step the reaction of methanol and Mono ethanolamine takes place at a molar ratio in the range of 1.0-0.6 to 3.0-0.4, at a temperature of 45-50° C., under stirring, for 2.5 hours at pH −11.

Physical-Chemical Indicators

| Name of the indicator | Standard |
|---|---|
| External (visual) appearance | Homogeneous, transparent liquid with low |
| | alcohol smell |
| Hydrogen index, pH | 10.5-11.0 |
| Density, g/cm³ | 0.96 |

In aqueous solutions, methanol, as a weak acid, dissociates to form the methylate-ion of hydrogen proton according to the following scheme:

CH₃OH+H₂O→CH₃O⁻+H₃O⁺

And Ethanolamines in aqueous solutions are represented by the following polar particles:

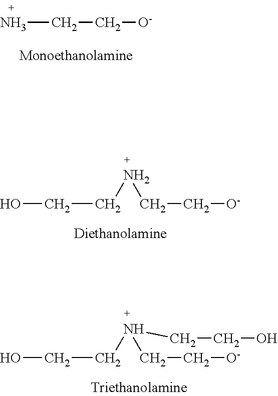

Upon interaction, the nucleophilic attack on the protonated nitrogen atom of ethanolamine takes place according to the following scheme, for example mono ethanolamine:

H₃N⁺—CH₂—CH₂—O⁻+CH₃—O⁻→(CH₃O⁻) N⁺H₃—CH₂—CH₂—O⁻

At the interaction, the nucleophilic attack on the protonated nitrogen atom of ethanolamine by methylate ion is carried out according to the following scheme, for example mono-ethanolamine:

H₃N⁺—CH₂—CH₂—O⁻+CH₃—O⁻→(CH₃O⁻) N⁺H₃—CH₂—CH₂—O⁻

followed by a second step, in which the reaction of the product obtained in the first step at a temperature of 55-60° C. for 1.5 hours, is continuously stirred, at a pH-11. At the negative end of the formed particle, water dipoles adhere, forming a stable hydrate membrane. Ethoxylated Nonylphenol (Rokanol NL8) with ethoxylation degree 30—as nonionic surfactant. Under these conditions, the reaction is related to the formation, due to the intermolecular links in the stage of limiting the adhering process-of the associate with the following structure

xCH₃OH+NH_{y}—(CH₂—CH₂—OH)ₓ→{[NH_{y}—(CH₂—CH₂—OH₂)ₓ]⁺[(CH₃O)ₓ]⁻}

Where:
x=1 -3
y=0-2
x+y=3

Depending on the conditions created, both reaction mechanisms may be achieved, and the limiting stage includes the nucleophilic attack of alcohol or water on the carbon atom of the NCO group, with the displacement of the hydrogen atom in the activated nitrogen or oxygen complex.

The methylate is obtained in two stages of the preparation process:
1)—by the interaction of methanol with ethanolamine in a molar ratio of 1.0: 0.6;
2)—with subsequent condensation with Rokanol NL 8 (ethoxylated monoalkylphenols based on propylene trimers) as a sealant with the role of encapsulating the substance. Under these conditions, the development of the reaction is related to the formation, due to the intermolecular boundaries in the limiting stage, of the adherence product to the associate having the following structure:

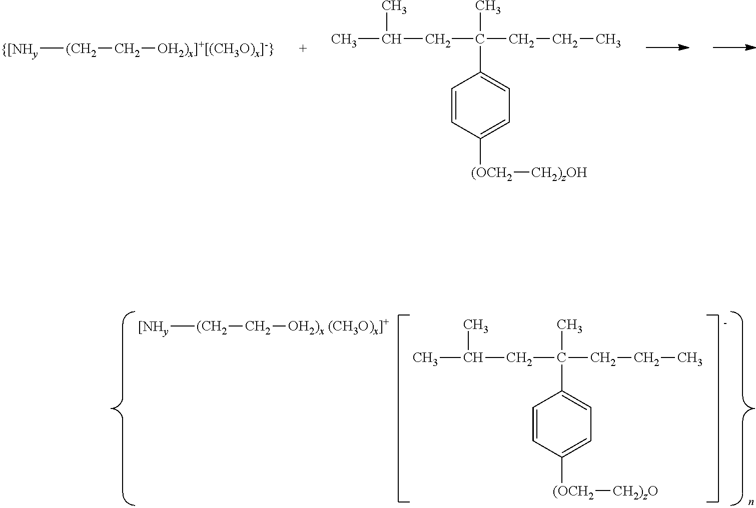

Where:
x=1- 3
y=0-2
x+y=3
z=6-9

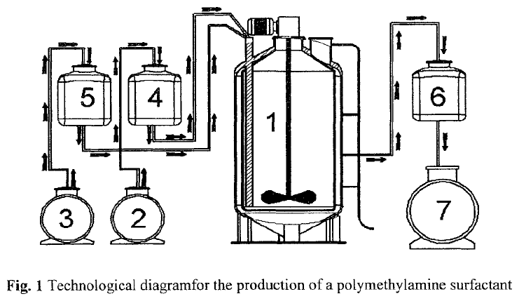

An example of the invention will now be described. In FIG. 1 the scheme of the system corresponding to the Poly Methylamine surfactant preparation process is showed. The installation consists of a reactor 1, optionally provided with a mixer for mixing the raw materials in which both stages of the process are carried out, an apparatus for receiving the finished product (2), a measuring vessel for methanol (3), a an ethanolamine metering vessel (4), a methanol storage tank (5), an ethanolamine storage tank (6) and a storage tank for the product (7)

Stage I. Obtaining Ethanolamine Methylate

In the stainless steel unit 1 (diagram) with capacity of 10 m³, equipped with frame mixer, external heater/cooling jacket is added through the visiting hole of 5.500 kg (5.0 m³) of technical Methyl Alcohol. The mixer with quantities of 1000 kg (1.0 m³) is started, through the visiting hole 4, and 3500 kg of mono ethanolamine is added. At the same time, the reactive mass self-heating is taking place and by pumping the water into the outer cooling jacket, a 45-50° C. temperature of the reactive mass inside the reactor is maintained. Keeping the temperature up to 50° C. is explained by the fact that methanol and ethanolamine are unstable organic compounds, high temperatures they may decompose with the separation of toxic compounds. After mixing and keeping this condition for 2.5 hours, Ethanolamine Methylate is obtained, which is widely used as catalyst for the production of biodiesel from vegetable and animal oils, for the re-etherification of fats and oils in cosmetics industry, etc. In the same apparatus, the reactive mass sealing reaction is carried out.

Stage II. Sealing the Ethanolamine Methylate Solution and Producing Poly Methylamine (PMTA)

In the stainless steel unit 1 (diagram) with capacity of 10 m³, equipped with frame mixer, external heater/cooling jacket, 14 kg of sealant—Rokanol NL 8 is added through the hatch. The mixer is started. A temperature of 55-60° C. is kept, by pumping the hot water into the outer jacket of the apparatus. After the exposure to this condition for 1.5 hours, the product obtained is analysed and allowed to flow by self-flowing into receiver no. 6 of the apparatus and then into the storage tank no. 7.

The process, according to the invention, is devoid of toxic or dangerous waste, as well as atmospheric releases are missing, thus ensuring the protection of the environment, as shown in Table 1, in which the values obtained in waste water analysis are reproduced. SR EN 903/2003 describes the spectro-metric method for determining the anionic surfactant content by measuring the MBAS methylene blue index in the waste water from 0.1 to 5.0 mg/L. The spectrometric method can be used for waters with a surface agents content greater than 5.0 mg/L by properly diluting the waste water samples.

Principle of the method: formation of coloured salts in alkaline medium between methylene blue and anionic surface agents. Extraction of these salts into chloroform and acid treatment of the chloroform solution. Removal of interferences by extraction of the anionic substance complex—methylene blue from the alkaline solution and stirring of the extract with methylene blue acid solution. Separation of the organic phase and spectrometric measurement of absorbance at the wavelength of the maximum absorption (650 nm). All the results are represented in the table below:

TABLE 1
Data obtained from residual water analysis

| The name of the | Where it | Quantity | | periodicity | Characteristic of waste water | | | Note |
|---|---|---|---|---|---|---|---|---|
| waste water and of | flows | | | | | | | |
| the noxious sub- | | | | | | | | |
| stances in it, | | | | | | | | |
| the appliance, | | | | | | | | |
| the stove | | | | | | | | |
| | | m³ | m³ in | | Composition of waste waters | | Admissible | |
| | | per | 24 | | | | quantity | |
| | | year | hours | | | | of harmful | |
| | | | | | | | substances | |
| | | | | | Name of indicator, | Indication | | |
| | | | | | unit of measure | of the | | |
| | | | | | | indicator | | |
| Mechanical losses | For | 58 | 0.5 | once | Mass fraction, % | | | |
| Apparatus 1 | ignition | | | within | | | | |
| | | | | 24 hours | | | | |
| | | | | | methylated of | 00.0 | | |
| | | | | | ethanolamine | | | |
| Pierderi | For | 20 | 0.4 | once | Mass fraction, % | | | |
| mecanice la | ignition | | | within | PME disperser | 00.0 | | |
| bottling in | | | | 24 hours | | | | |
| the packaging | | | | | | | | |

1) Multifunctional, ecological Poly Methylamine surfactant, with surface active (surfactant) properties, characterized in that:
a) the methanol interaction with Mono Ethanolamine, in a molar ratio of 1.0:0.6, produces mono ethanolamine methylate—as intermediate product, subsequent condensation with Ethoxylate Nonylphenol (Rokanol NL8) as a sealant as a non-ionic surfactant gives a surface active Poly Methylamine agent. 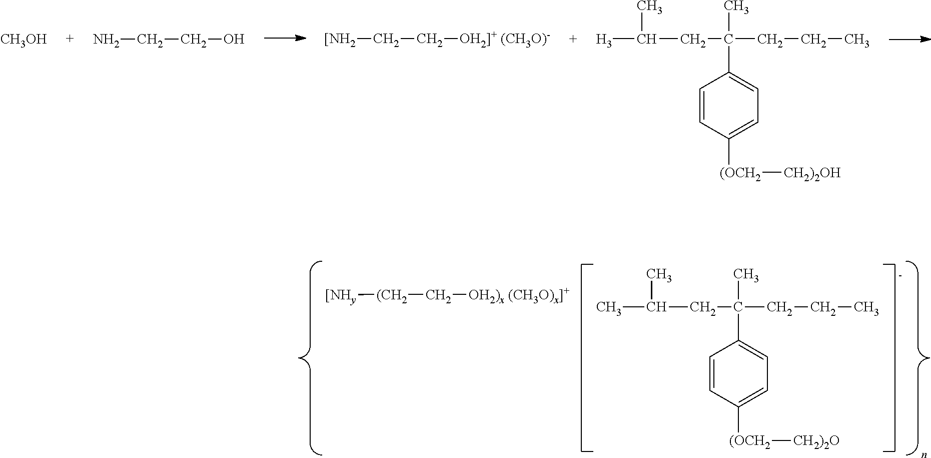
b) By the interaction of methanol with Diethanolamine in a molar ratio of 2.0:0.5 is obtained Methylate of Diethanolamine—as an intermediate product, subsequent condensation with Ethoxylate Nonylphenol (Rokanol NL8) as sealant as a non-ionic surfactant, Poly Methylamine surface active agent is obtained. 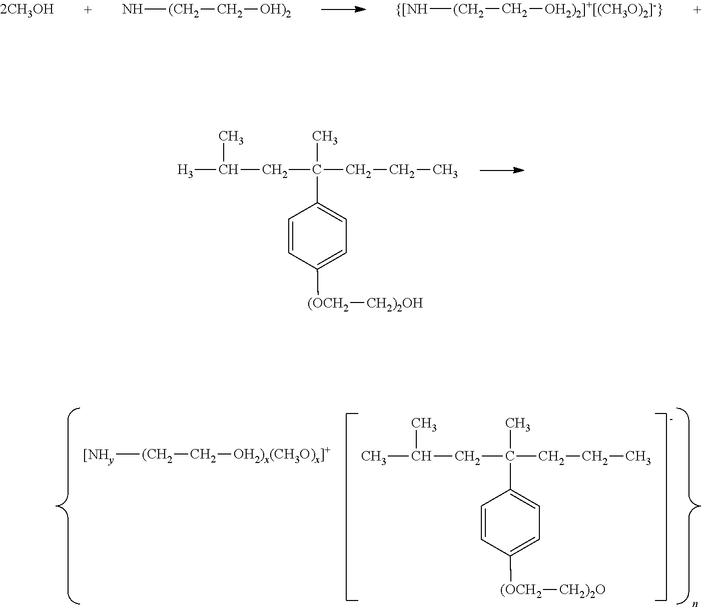
c) By the interaction of Methanol with Triethanolamine in a molar ratio of 3.0:0.4, triethanolamine methylate- as intermediate product is obtained, subsequent condensation with Ethoxylated Nonylphenol (Rokanol NL8) as a sealant as a non-ionic surfactant, a Poly Methylamine surface active agent is obtained.

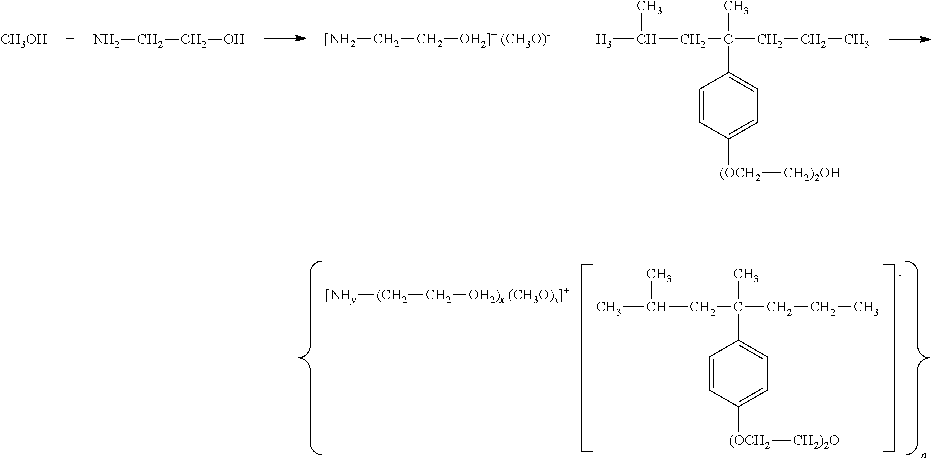

2) Poly Methylamine surfactant used as a fuel additive, characterized by reducing exhaust emissions to the atmosphere, raising the octane number in gasoline, preventing the formation of ice crystals in diesel and being anticorrosive.

3) Process for the preparation of a Poly Methylamine surface active agent (surfactant) characterized in that it takes place in the first step by reacting methanol and an ethanolamine at a molar ratio of 1.0-0.6 to 3.0-0.4 at a temperature of 45-50° C. to 55-60° C. with stirring for 2.5 hours:
xCH₃OH+NH_{y}—(CH₂—CH₂—OH)ₓ→{[NH_{y}—(CH₂—CH₂—OH₂)ₓ]⁺[(CH₃O)ₓ]⁻}
where
x=1-3
y=0-2
x+y=3
followed by a second step in which the reaction between the product obtained in the first step and the Ethoxylated Nonylphenol having the degree of Ethoxylation 30 at 55-60° C. takes place for 1.5 hours. 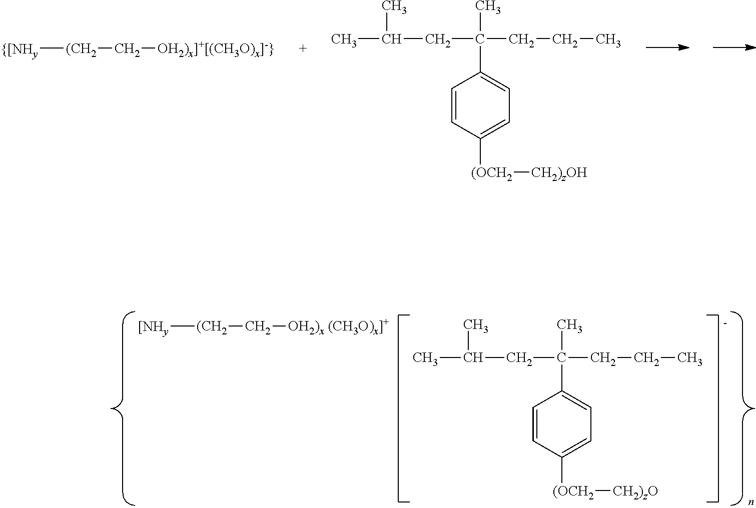
Where:
x=1-3
y=0-2
x+y=3
z=6 -9

4) Process according to claim 3, characterized in that the optimal temperature is from 45-50° C. to 55-60° C.

5) Process according to claim 3, characterized in that the molar ratio of methanol:ethanolamine is from 1.0-0.6 to 3.0-0.4.
